(19) United States
(12) Patent Application Publication
(10) Pub. No.: US 2022/0309165 A1
(43) Pub. Date: Sep. 29, 2022

(54) INFORMATION PROCESSING APPARATUS, INFORMATION PROCESSING METHOD, AND NON-TRANSITORY COMPUTER READABLE MEDIUM

(71) Applicant: FUJIFILM Business Innovation Corp., Tokyo (JP)

(72) Inventors: Ryo KUKIMIYA, Kanagawa (JP); Masamichi TAKAHASHI, Kanagawa (JP); Koki UWATOKO, Kanagawa (JP); Takeshi ZENGO, Kanagawa (JP)

(73) Assignee: FUJIFILM Business Innovation Corp., Tokyo (JP)

(21) Appl. No.: 17/384,052

(22) Filed: Jul. 23, 2021

(30) Foreign Application Priority Data
Mar. 26, 2021 (JP) 2021-054208

(51) Int. Cl. G06F 21/57; G06F 21/62

(52) U.S. Cl. CPC G06F 21/577; G06F 21/6218; G06F 2221/2101

(57) ABSTRACT

An information processing apparatus includes a processor configured to: obtain operation information relating to an operation performed on an information asset, the operation information including degree of secrecy of the information asset operated, a time period of the operation, and a place of the operation; determine a security risk of the operation performed on the information asset based on the operation information; and display a determined security risk of the operation on a display apparatus using a graphic, the graphic indicating an operator of the operation performed on the information asset and representing a level of risk using a predetermined display mode.

### CROSS-REFERENCE TO RELATED APPLICATIONS

This application is based on and claims priority under 35 USC 119 from Japanese Patent Application No. 2021-054208 filed Mar. 26, 2021.

### BACKGROUND

### (i) Technical Field

The present disclosure relates to an information processing apparatus, an information processing method, and a non-transitory computer readable medium.

### (ii) Related Art

With regard to access to information assets, security risks are being assessed.

Japanese Unexamined Patent Application Publication No. 2020-87119 discloses an information processing apparatus that obtains a log of operation on an information asset accessed by a user, determines a security risk of the user in response to an operation indicated by the obtained log based on security risks defined in advance regarding details of a series of operations performed on the information asset, and visualizes the determined security risk.

### SUMMARY

The security risk of an information asset may be assessed differently depending on the type of the information asset operated, the time when the information asset is operated, the place where the information asset is operated, and the like. Therefore, as a security measure, it is desirable to present to a user a security risk based on the time period of an operation and/or the place of an operation performed on an information asset.

Aspects of non-limiting embodiments of the present disclosure relate to a technique to present, to a user, a security risk reflecting information about a mode of operation performed on an information asset, the information including a type of the information asset to be operated and at least one of the time period of the operation and the place of the operation, compared with the case where a security risk is determined according to details of operation performed on information assets. Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: obtain operation information relating to an operation performed on an information asset, the operation information including degree of secrecy of the information asset operated, a time period of the operation, and a place of the operation; determine a security risk of the operation performed on the information asset based on the operation information; and display a determined security risk of the operation on a display apparatus using a graphic, the graphic indicating an operator of the operation performed on the information asset and representing a level of risk using a predetermined display mode.

### BRIEF DESCRIPTION OF THE DRAWINGS

An exemplary embodiment of the present disclosure will be described in detail based on the following figures, wherein:

FIG. 1 is a diagram illustrating a configuration of a risk management system to which a present exemplary embodiment is applied;

FIG. 2 is a diagram illustrating an exemplary hardware configuration of a management server and a terminal apparatus according to the present exemplary embodiment;

FIG. 3 is a diagram illustrating an exemplary data configuration of access history retained in an access log DB;

FIG. 4 is a diagram illustrating an exemplary data configuration of access history retained in the access log DB when a place of access is estimated;

FIG. 5 is a diagram illustrating an exemplary data configuration of information about degree of secrecy retained in a degree of secrecy DB;

FIG. 6 is a diagram illustrating an exemplary data configuration of user attribution information retained in a user attribution DB;

FIG. 7 is a flowchart illustrating an acquisition operation of access history in a terminal apparatus;

FIG. 8 is a flowchart illustrating a generation operation of a risk visualization image by the management server;

FIG. 9A is a table illustrating exemplary setting of first risk values;

FIG. 9B is a table illustrating exemplary setting of second risk values;

FIG. 9C is a table illustrating exemplary setting of third risk values;

FIG. 10 is a diagram illustrating an exemplary configuration of aggregated data when a risk visualization image using a floor map is selected;

FIG. 11 is a diagram illustrating an exemplary configuration of aggregated data when a risk visualization image using an organization chart is selected;

FIG. 12 is a diagram illustrating an example of the risk visualization image using a floor map;

FIG. 13 is a diagram illustrating an example of the risk visualization image using an organization chart; and

FIG. 14 is a diagram illustrating an example of a display image of detailed information.

### DETAILED DESCRIPTION

Hereinafter, exemplary embodiments of the present disclosure are described in detail with reference to the attached drawings.

Overall Configuration

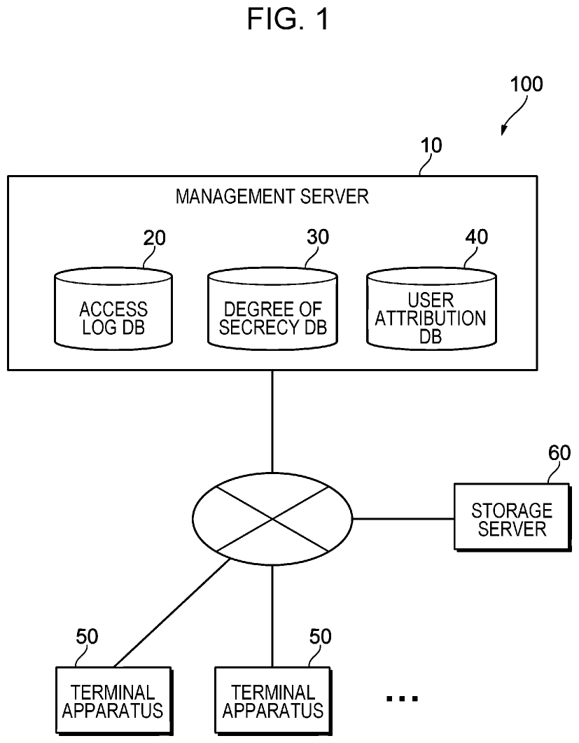

FIG. 1 is a diagram illustrating a configuration of a risk management system to which a present exemplary embodiment is applied. A risk management system 100 includes a management server 10 and a plurality of terminal apparatuses 50 managed by the management server 10. The terminal apparatus 50 is connected to a storage server 60 that retains files available to the terminal apparatus 50.

The terminal apparatus 50 is an information processing apparatus to be used by a user to access files that are information assets. Hereinafter, a file that may be accessed by this terminal apparatus 50 is referred to as an “information file”. Upon accessing an information file, the terminal apparatus 50 generates history information relating to details of the access. Hereinafter, this history information is referred to as an “access history”. The access history generated in the terminal apparatus 50 is sent to the management server 10. Specifically, the terminal apparatus 50 is a desktop personal computer, a laptop personal computer that a user may carry around, or the like. Depending on the type of an information file to be accessed, an information terminal such as a tablet terminal, a smartphone, or the like may also be used as the terminal apparatus 50.

The information file is a file on which information whose degree of secrecy is set is recorded. The type of information medium is not limited to a particular type and may be a document file in which information is recorded as a document, an image file in which information is recorded as an image, an audio file in which information is recorded as audio data, or the like. These information files are retained in the storage server 60 or a storage apparatus of the terminal apparatus 50.

The storage server 60 is a server that retains information files. The storage server 60 is a server formed on a network to which the terminal apparatus 50 is connected and may be realized using a cloud server or the like. As described above, in the present exemplary embodiment, the storage server 60 does not necessarily retain all of information files that are access targets of the terminal apparatus 50, and part or all of the information files may be retained in one or more of the terminal apparatuses 50.

The management server 10 is a server that manages security risks (hereinafter, simply referred to as “risks”) of access to an information file made by the terminal apparatus 50. The management server 10 determines and presents a risk associated with details of the access to an information file by the terminal apparatus 50, which is a management target. The management server 10 is a server formed on a network to which the terminal apparatus 50 is connected and may be realized using a cloud server or the like.

The management server 10 includes an access log database (DB) 20, a degree of secrecy database (DB) 30, and a user attribution database (DB) 40. The access log DB 20 is a database that stores access histories generated when the terminal apparatus 50 accessed an information file. The degree of secrecy DB 30 is a database that stores information relating to the degrees of secrecy of information files. The user attribution DB 40 is a database that stores information relating to attributions of users who access information files using the terminal apparatuses 50.

The management server 10 obtains an access history generated when the terminal apparatus 50 accesses an information file and stores the access history in the access log DB 20. Subsequently, the management server 10 determines the risk at the time when a certain user accesses a certain information file using an access history stored in the access log DB 20, information of the degree of secrecy stored in the degree of secrecy DB 30, and information relating to the user attribution stored in the user attribution DB 40. In the present exemplary embodiment, the management server 10 determines a risk not only based on the degree of secrecy of an information file itself, which is an access target, but also based on the place and the time where the access is made. A specific calculation method for determining the risk will be described later.

Furthermore, the management server 10 generates an image that visualizes the calculated risk and displays the image on a display apparatus. Hereinafter, this image that visualizes the risk is referred to as a “risk visualization image”. In the present exemplary embodiment, it is assumed that as specific examples of the risk visualization image, an image that uses a map indicating a place where access to an information file is made and an image that uses an organization chart indicating a position of a user who accessed an information file in an organization may be generated. Specific contents of such risk visualization image will be described later.

Hardware Configuration

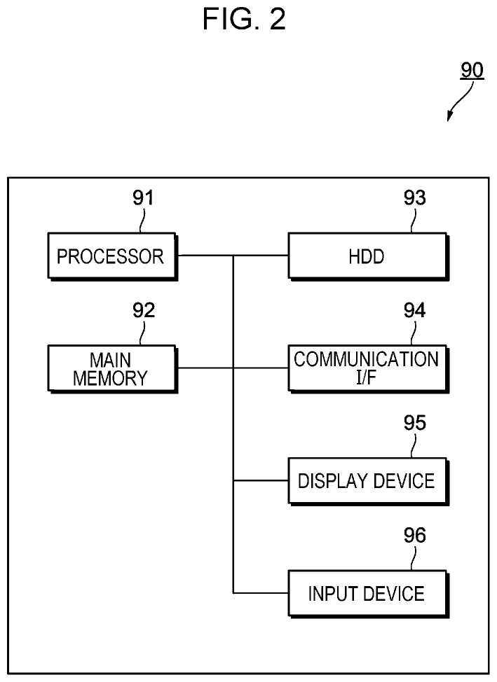

FIG. 2 is a diagram illustrating an exemplary hardware configuration of the management server 10 and the terminal apparatus 50 according to the present exemplary embodiment. Here, each apparatus is represented by a computer 90. As illustrated in FIG. 2, the computer 90 includes a processor 91, a main memory 92, and a hard disk drive (HDD) 93. The processor 91 runs a variety of software such as an operating system (OS), applications, and the like to implement respective functions in each apparatus. The main memory 92 is a memory area for storing a variety of software, data to be used for running the software, and the like, and the HDD 93 is a memory area for storing input data for a variety of software, output data from the variety of software, and the like. Furthermore, the computer 90 includes a communication interface (communication I/F) 94 for external communication, a display device 95 such as a display or the like, and an input device 96 such as a keyboard, a mouse, and the like.

In the case where the management server 10 is realized by the computer 90 illustrated in FIG. 2, the calculation of a risk relating to access and the generation of a risk visualization image are performed, for example, by running one or more programs on the processor 91. The generated risk visualization image is displayed, for example, on the display device 95. The reception of an access history from the terminal apparatus 50 is performed, for example, by controlling the communication I/F 94 by running one or more programs on the processor 91. The access log database (DB) 20, the degree of secrecy database (DB) 30, and the user attribution database (DB) 40 are realized, for example, by the HDD 93, and data stored in each database are managed by a management function that is implemented by running one or more programs on the processor 91.

In the case where the terminal apparatus 50 is realized by the computer 90 illustrated in FIG. 2, access to an information file retained in an external apparatus, such as the storage server 60 or the like, is made, for example, by controlling the communication I/F 94 by running one or more programs on the processor 91. The operation performed on the accessed information file and the generation of an access history are performed, for example, by running one or more programs on the processor 91. The transmission of the generated access history to the management server 10 is performed, for example, by controlling the communication I/F 94 by running one or more programs on the processor 91.

Exemplary Configuration of Access Log DB 20

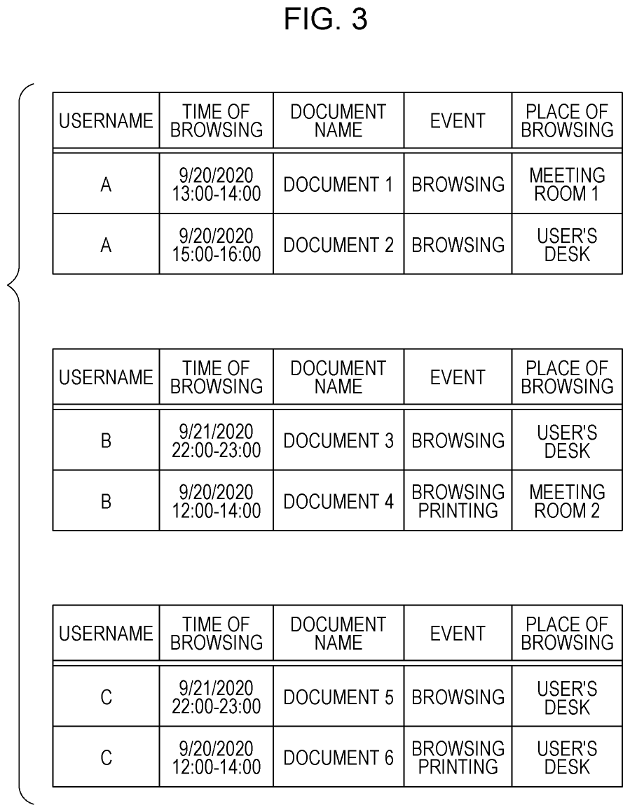

FIG. 3 is a diagram illustrating an exemplary data configuration of access history retained in the access log DB 20. With regard to access to information files made by the terminal apparatuses 50, the access log DB 20 illustrated in FIG. 3 registers and manages information about respective items of “USERNAME”, “TIME OF BROWSING”, “DOCUMENT NAME”, “EVENT”, and “PLACE OF BROWSING” for each user.

The “USERNAME” is the name of a user who accessed an information file relating to an individual access history. This user is an operator who performs an operation of making access to an information file. Note that this item may be any information that enables to identify the user and is not limited to the username. For example, this item may be information such as an ID, a code, or the like that is assigned to a user in such a way that the information enables to distinguish each user.

The “TIME OF BROWSING” is information about date and time when the access to the information file is made. Here, as an example of the case where the information file is a document file, the item name is set to the time of browsing. However, in the case where the information file is an image file or an audio file, this item name may be set to the time of replay or the like.

The “DOCUMENT NAME” is the name of the accessed information file. Note that this item may be any information that enables to distinguish the information file and is not limited to the name of an information file. For example, instead of the document name, information such as an ID, a code, or the like, which is assigned to an information file in such a way that the information enables to distinguish each information file, may be used.

The “EVENT” is information that indicates details of the operation performed on an information file accessed by the terminal apparatus 50. An operation that may be recorded as an event is defined according to the type of an information file. For example, in the case where the information file is a document file, examples of the event include operations such as browsing, editing, printing, copying, and the like. In the case where the information file is an image file or an audio file, examples of the event include operations such as replaying, editing, copying, and the like.

The “PLACE OF BROWSING” is information about the place where a user accessed an information file using the terminal apparatus 50. Here, as an example of the case where the information file is a document file, the item name is set to the place of browsing. However, in the case where the information file is an image file or an audio file, this item name may be set to the place of replay or the like.

With regard to the information about the place of browsing, in some cases, the place of browsing may be directly identified from the identification information of the terminal apparatus 50, and in the other cases, the place of browsing may not be directly identified from the identification information of the terminal apparatus 50. In the case where the terminal apparatus 50 is an apparatus that may not be carried around like a desktop personal computer, an installation location of the terminal apparatus 50 may be registered in advance, and the place may be identified from the identification information of the terminal apparatus 50. On the other hand, in the case where the terminal apparatus 50 is an apparatus that may be carried around like a laptop personal computer, a tablet terminal, or the like, the place where access to an information file is made may not be identified even if the terminal apparatus 50 and the user are identified. Thus, in such case, the management server 10 estimates the place where access to an information file is made and records information about the estimated place in the database.

An estimation method of the place of access is now described. As an example, in the case where the terminal apparatus 50 accesses an information file using a wireless channel such as Wi-Fi or the like, it is conceivable to estimate a location based on the intensity of a radio wave from a wireless router received by the terminal apparatus 50. The intensity of a radio wave received by the terminal apparatus 50 is stronger when the radio wave is coming from a wireless router closer to the terminal apparatus 50 and weaker when the radio wave is coming from a wireless router away to the terminal apparatus 50. Accordingly, based on intensities of radio waves received from a plurality of wireless routers, distances from the terminal apparatus 50 to respective ones of the plurality of wireless routers are calculated, and based on a calculation result, a relative location of the terminal apparatus 50 to the plurality of wireless routers may be found. Subsequently, by identifying installation locations of the respective wireless routers on a map, the location of the terminal apparatus 50 may be identified on that map.

As another example of the estimation method of the place of access, it is conceivable to identify the location of the terminal apparatus 50 using an IP address. For example, in the case where a unique IP address is set for each floor, each room, each desk, or the like within a local area network (LAN) constructed in a certain building, the floor, the room, the desk, or like where the terminal apparatus 50 is installed may be identified from the IP address of the terminal apparatus 50. For example, assuming the case where, in a certain building, IP addresses 192.168.11.1 to 192.168.11.255 are assigned to information devices on the first floor, IP addresses 192.168.12.1 to 192.168.12.255 are assigned to information devices on the second floor, IP addresses 192.168.13.1 to 192.168.13.255 are assigned to information devices on the third floor, IP addresses 192.168.14.1 to 192.168.14.255 are assigned to information devices on the fourth floor, the place of access may be identified as follows. When the IP address of the terminal apparatus 50 is 192.168.12.2, the place of access is the user□s desk on the second floor, when the IP address of the terminal apparatus 50 is 192.168.13.10, the place of access is a meeting room on the third floor, and the like.

Note that these estimation methods are merely examples, and as the method for estimating the location of the terminal apparatus 50 that is used to access an information file, various existing methods that enable the estimation of the location of an information device may be used. For example, the location of the terminal apparatus 50 may be identified by using a transceiver device capable of identifying the location such as a Beacon that uses Bluetooth (registered trademark), or the location of the terminal apparatus 50 may be identified by using a global positioning system (GPS) function or the like.

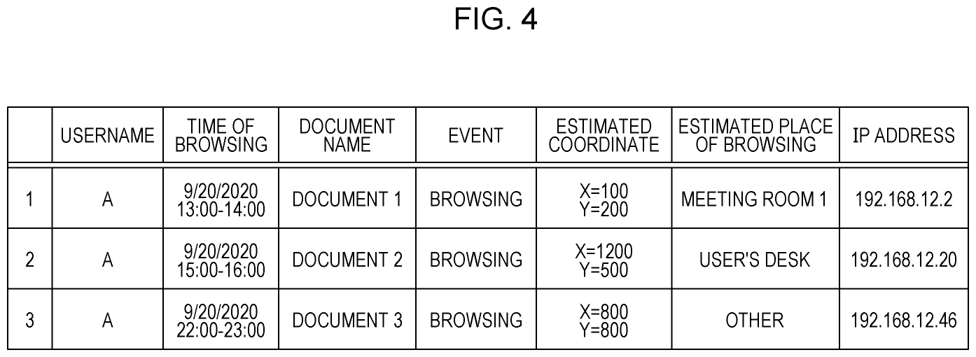

FIG. 4 is a diagram illustrating an exemplary data configuration of access history retained in the access log DB 20 when the place of access is estimated. With regard to access to an information file made by the terminal apparatus 50, the access log DB 20 illustrated in FIG. 4 registers and manages information about respective items of “USERNAME”, “TIME OF BROWSING”, “DOCUMENT NAME”, “EVENT”, “ESTIMATED COORDINATE”, “ESTIMATED PLACE OF BROWSING”, and “IP ADDRESS” for each user. Of these items, the “USERNAME”, the “TIME OF BROWSING”, the “DOCUMENT NAME”, the “EVENT” are substantially the same items as in the exemplary data configuration illustrated in FIG. 3.

The “ESTIMATED COORDINATE” is, for example, coordinate values indicating an estimated location of the terminal apparatus 50 in an X-Y coordinate set for the floor. For example, in the case where the location of the terminal apparatus 50 is estimated based on the intensities of radio waves from wireless routers, a relative location of the terminal apparatus 50 to each wireless router is identified based on the intensity of a radio wave from each wireless router as described above. Accordingly, if the coordinate values of each wireless router on the floor are identified, the coordinate values indicating the location of the terminal apparatus 50 is also identified.

The “ESTIMATED PLACE OF BROWSING” is information indicating the place where a user accessed an information file, which is identified based on the estimated location of the terminal apparatus 50. The location of a room or a desk on the floor is identified by the X-Y coordinate set up for the floor described above. From the place on the floor which is indicated by the estimated coordinate values of the terminal apparatus 50 used to access an information file, the place of access is identified as the user□s desk, a meeting room, or the like. Here, as an example of the case where the information file is a document file, the item name is set to the estimated place of browsing. However, in the case where the information file is an image file or an audio file, this item name may be set to the estimated place of replay or the like.

The “IP ADDRESS” is the IP address of the terminal apparatus 50 used to access an information file. With regard to the estimation method of the place of access using IP address, as described above, depending on setting of IP address, the place of access may be identified as the user□s desk, a meeting room, or the like based on the IP address of the terminal apparatus 50.

Exemplary Configuration of Degree of Secrecy DB 30

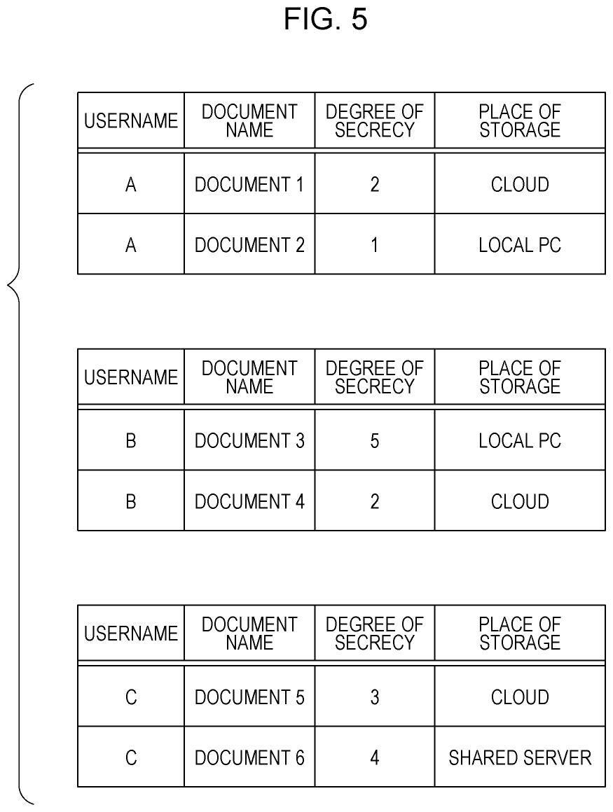

FIG. 5 is a diagram illustrating an exemplary data configuration of information about the degree of secrecy retained in the degree of secrecy DB 30. With regard to information files, the degree of secrecy DB 30 illustrated in FIG. 5 registers and manages information about respective items of “USERNAME”, “DOCUMENT NAME”, “DEGREE OF SECRECY”, and “PLACE OF STORAGE” for each user.

The “USERNAME” is the name of a user who owns an information file. Note that this item may be any information that enables to identify the user and is not limited to the username. For example, this item may be information such as an ID, a code, or the like that is assigned to a user in such a way that the information enables to distinguish each user.

The “document name” is the name of an information file under the control. Note that this item may be any information that enables to distinguish the information file and is not limited to the name of an information file. For example, instead of the document name, information such as an ID, a code, or the like, which is assigned to an information file in such a way that the information enables to distinguish each information file, may be used.

The “DEGREE OF SECRECY” is information indicating the degree of secrecy set for an information file. This degree of secrecy is set, for example, in a stepwise manner according to the range of users who have the authority to perform an operation on an information file or like. For example, a five-level degree of secrecy like in the following example may be set. In this example, the degree of secrecy increases in a stepwise manner from degree of secrecy 1 to degree of secrecy 5. Here, it is assumed that an information file is a document file prepared within a company.

Degree of secrecy 1: outside document, document for publication

Degree of secrecy 2: document for in-house use only, available for browsing in all divisions

Degree of secrecy 3: document for in-house use only, available for browsing in the user□s division

Degree of secrecy 4: document for in-house use only, available only for restricted members in the user□s division

Degree of secrecy 5: highly confidential document for management

In the example of the degree of secrecy described above, the document available for browsing in all divisions means that the document may be browsed by employees of all the divisions in the company. The document available for browsing in the user□s division means that the document may be browsed by employees belonging to the same division as the user who owns an information file in the company. The document available only for restricted members in the user□s division means that the document may be browsed only by employees who are selected in a limited manner and belong to the same division as the user who owns an information file in the company. The highly confidential document for management means that the document may be browsed only by employees who belong to the management.

The “PLACE OF STORAGE” is information indicating the place where an information file is stored. For example, the “PLACE OF STORAGE” may be the storage server 60, one of the terminal apparatuses 50, or any other external server. The one of the terminal apparatuses 50 may be the terminal apparatus 50 of the user who owns an information file, or the terminal apparatus 50 of another user when the information file is, for example, the degree of secrecy 1 or the degree of secrecy 2 described above. The external server may be a server or the like that is used for a service different from that of the storage server 60.

Exemplary Configuration of User Attribution DB 40

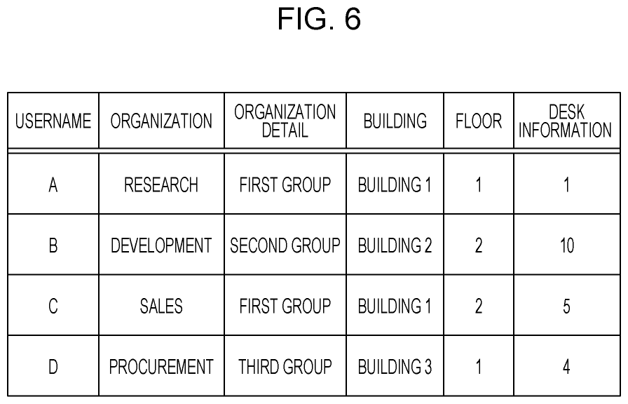

FIG. 6 is a diagram illustrating an exemplary data configuration of attribution information of users retained in the user attribution DB 40. With regard to users of information files, the user attribution DB 40 illustrated in FIG. 6 registers and manages information about respective items of “USERNAME”, “ORGANIZATION”, “ORGANIZATION DETAIL”, “BUILDING”, “FLOOR”, and “DESK INFORMATION”.

The “USERNAME” is the name of a user who may access an information file under the control of the management server 10. Note that this item may be any information that enables to identify the user and is not limited to the username. For example, this item may be information such as an ID, a code, or the like that is assigned to a user in such a way that the information enables to distinguish each user.

The “ORGANIZATION” is information that identifies the organization to which each user belongs. This item may be any information that enables to identify the organization, and for example, the name of the organization is recorded. Instead of the name of the organization, information such as an ID, a code, or the like that enables to distinguish each organization may be recorded.

The “ORGANIZATION DETAIL” is information that identifies a sub-organizational unit to which each user belongs in the case where the organization is divided into sub-organizational units. For example, in the case where there is a plurality of groups each including several users as the group members in the organization, information that identifies this group is recorded. This item name may be any information that enables to identify the sub-organizational unit, and information such as an ID, a code, or the like that enables to distinguish each group name or each group is recorded.

The “BUILDING” is information that identifies the building in which the user□s desk is placed. This item may be any information that enables to identify the building, and for example, the name of the building is recorded. Instead of the name of the building, information such as an ID, a code, or the like that enables to distinguish the building may be recorded.

The “FLOOR” is information that identifies, in the building where the user□s desk is placed, the floor on which the user□s desk is placed. This item may be any information that enables to identify the floor, and for example, the floor number is recorded. Instead of the floor number, information such as an ID, a code, or the like that enables to distinguish the floor may be recorded.

The “DESK INFORMATION” is information that identifies the desk of a user on the floor. This item may be any information that enables to identify the user□s own desk, and for example, information such as an ID, a code, or the like that enables to distinguish the desk for each user is recorded. This desk information is information that identifies a place in map information of the floor. Hereinafter, this map information of a floor is referred to as a “floor map”. Accordingly, information recorded as the desk information corresponds to the place where the user□s desk is placed on the floor map.

Acquisition Operation of Access History

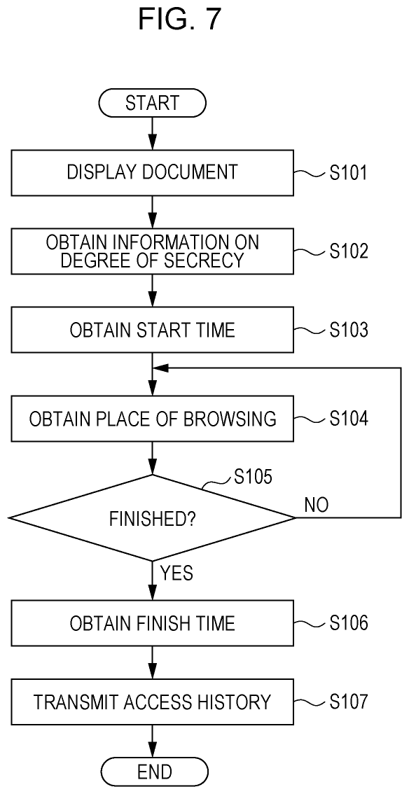

FIG. 7 is a flowchart illustrating an acquisition operation of access history in the terminal apparatus 50. Here, an example is described using a case where a document file, which is as an information file, is accessed for document browsing. A user logs in the risk management system 100 using the terminal apparatus 50 and accesses the document files to be browsed under the control of the management server 10. Upon logging in, the user and the terminal apparatus 50 used are identified and linked to each other. Upon obtaining the document file, the terminal apparatus 50 displays a document on a display apparatus (for example, the display device 95 illustrated in FIG. 2) (S101). The terminal apparatus 50 also obtains information about the degree of secrecy of the document file from the degree of secrecy DB 30 (S102). Subsequently, the terminal apparatus 50 obtains information about the start time of the display of the document and the place of browsing (S103, S104). Note that the information about the place of browsing may be identified by estimating the place of browsing as described with reference to FIG. 4.

Until the display of the document ends, the terminal apparatus 50 repeats the operation of acquisition of the information about the place of browsing at intervals of a certain time period (for example, every 1 minute) (NO in S105, S104). When the user performs an end operation and the display of the document ends (YES in S105), the terminal apparatus 50 obtains information about the finish time of the display of the document (S106). Subsequently, the information obtained in S102, S103, S104, and S106 are transmitted to the management server 10 as the access history (S107). Upon obtaining the access history, the management server 10 stores the access history in the access log DB 20 as the access history of the user identified by the login information. Note that in the operations described above, the terminal apparatus 50 obtains the information about the degree of secrecy of the obtained document file. However, because the information about the degree of secrecy may be obtained by looking up the degree of secrecy DB 30 if the document file is identified, the information about the degree of secrecy may not need to be obtained by the terminal apparatus 50 at the time of browsing.

Generation Operation of Risk Visualization Image

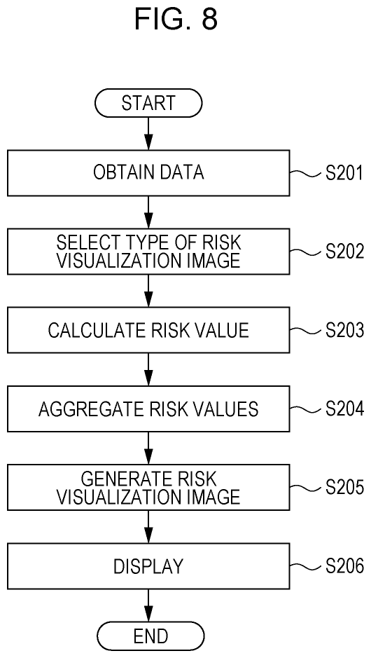

FIG. 8 is a flowchart illustrating a generation operation of a risk visualization image by the management server 10. A user (administrator) of the management server 10 instructs the management server 10 to generate a risk visualization image in order to find out a risk relating to a user□s access to an information file. Upon receiving a generation instruction of a risk visualization image, the management server 10 reads out data from the access log DB 20, the degree of secrecy DB 30, and the user attribution DB 40 (S201). At this time, data in the pertinent range are read out by designating conditions such as the date and time, the place, the organization, and the like in the generation instruction. Next, the management server 10 receives a designation of the type of a risk visualization image and selects the type of a risk visualization image to be generated (S202).

Next, based on the data obtained in S201, the management server 10 calculates the risk value for each access action to an information file by a user (S203). Subsequently, the management server 10 aggregates risk values calculated for the respective access actions according to the type of the risk visualization image selected in S202 (S204). Here, the risk value is information representing the level of information leak risk caused by the access action to an information file by a user. A specific calculation method of a risk value will be described later.

Next, based on the risk value aggregated in S204, the management server 10 generates a risk visualization image of the type selected in S202 (S205). Subsequently, the management server 10 displays the generated risk visualization image on the display apparatus (S206). Specific examples of the display of the risk visualization image will be described later.

Risk Calculation Method

Next, an example of a risk calculation method is described. In the present exemplary embodiment, a comprehensive risk calculation is performed for access to an information file by considering, in addition to the risk based on the degree of secrecy of the information file itself, the risk based on the place where the access to the information file is made, and the risk based on the time when the access to the information file is made. In the present exemplary embodiment, a first risk value, a second risk value, and a third risk value are set in advance. The first risk value represents the risk based on the degree of secrecy of the information file itself, the second risk value represents the risk based on the place where the access to the information file is made, and the third risk value represents the risk based on the time when the access to the information file is made. Subsequently, the first to third risk values are identified based on a status when access to an information file is made, and a comprehensive risk value representing a comprehensive risk of this access is calculated.

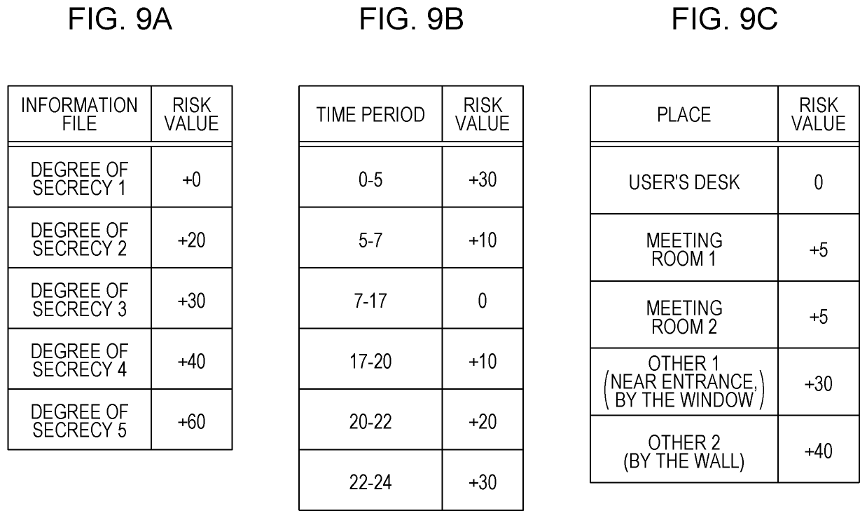

FIGS. 9A to 9C are diagrams illustrating exemplary settings of the risk values. FIG. 9A is a diagram illustrating an exemplary setting of the first risk value, FIG. 9B is a diagram illustrating an exemplary setting of the second risk value, and FIG. 9C is a diagram illustrating an exemplary setting of the third risk value. The first risk value illustrated in FIG. 9A is set according to the five-level degree of secrecy. In the example illustrated in FIG. 9A, a larger value is assigned for a higher degree of secrecy. For the second risk value illustrated in FIG. 9B, a day is divided into time periods of 0:00 to 5:00, 5:00 to 7:00, 7:00 to 17:00, 17:00 to 20:00, 20:00 to 22:00, and 22:00 to 24:00, and the value is set for each time period. In the example illustrated in FIG. 9B, a larger value is assigned for the access made in late night or early morning. The third risk values illustrated in FIG. 9C are set for places of five types that are the user□s desk, a meeting room 1, a meeting room 2, other 1 (near entrance, by the window), and other 2 (by the wall). In the example illustrated in FIG. 9C, a larger value is assigned for the place where the possibility of having a person other than the user is higher. Note that with regard to the third risk value, the setting value of each place may be varied depending on the time period. The third risk value may be set for a place not only in the same floor or the same building but also in an outside place. These classifications and values of each risk value are merely examples, and in practice, the risk values are set separately according to a security policy of an organization that uses the risk management system 100 of the present exemplary embodiment, a floor layout of a building, facilities, and the like.

Next, an exemplary equation for calculating the risk value is described. Assuming the case where a user accesses a certain information file of the degree of secrecy n at time t, the comprehensive risk value S(t) for this access is calculated by the following equation, where S1(t, n) is the first risk value, S2(t) is the second risk at time t, and S3(t) is the third risk value at the place where the access is made at time t:

S(t)=max(S1(t,n))+max(S2(t),S3(t))

Here, in the case where a user accesses a plurality of information files, of the first risk values of all the information files, the largest value is considered as the first risk value for this access. According to the foregoing equation, the comprehensive risk value is calculated by adding the maximum value of the first risk values based on the accessed information files to the value of the larger one of the second risk value based on the time of access and the third risk value based on the place of access.

As an example, the comprehensive risk value is calculated in the case where a certain user accesses an information file of the degree of secrecy 4 and an information file of the degree of secrecy 5 at 23:00 from a desk by the wall on the floor. In this case, the first risk value of the information file of the degree of secrecy 4 is +40, and the first risk value of the information file of the degree of secrecy 5 is +60. Thus, the maximum value of the first risk values is +60. Next, the second risk value at time of 23:00 is +30, and the third risk value of the place by the wall is +40. Thus, the maximum value of the second risk value and the third risk value is +40, which is the larger one. Accordingly, the comprehensive risk value is 100 (=60+40).

Note that this equation for calculation is merely an example, and the method for calculating the comprehensive risk value is not limited to the calculation using the foregoing equation. For example, it is conceivable to calculate the comprehensive risk value by adding the first risk value, the second risk value, and the third risk vale together.

Generation and Display of Risk Visualization Image

Next, the generation and display of a risk visualization image are described. In the present exemplary embodiment, as examples of the risk visualization image, an image using a floor map and an image using an organization chart are described. In order to generate these risk visualization images, the management server 10 aggregates the risk values calculated for the respective access actions according to the type of the risk visualization image selected in S202 as described in S204 of the flowchart of FIG. 8. For example, in the case where a risk visualization image using a floor map is selected, the aggregated data include information about the floor or the place of the terminal apparatus 50 that has accessed an information file. In the case where a risk visualization image using an organization chart is selected, the aggregated data include information about the organization to which a user who accessed an information file belongs.

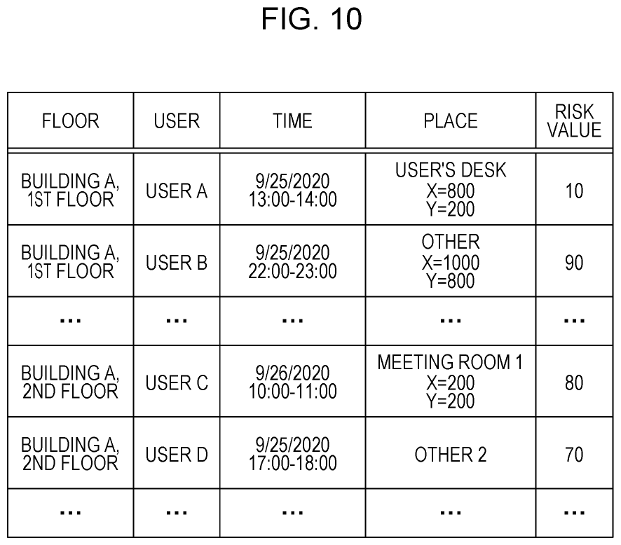

FIG. 10 is a diagram illustrating an exemplary configuration of the aggregated data when the risk visualization image using a floor map is selected. In the example illustrated in FIG. 10, as the aggregated data, information about respective items of “FLOOR”, “USER”, “TIME”, “PLACE”, and “RISK VALUE” are aggregated. These information items are aggregated every time access to an information file is made. The “FLOOR” and “PLACE” indicate the place where access to an information file is made. The “USER” indicates a user who accessed an information file. The “TIME” indicates the time period during which access to an information file is made. The “RISK VALUE” is the comprehensive risk value of the corresponding access. Because FIG. 10 is aggregated data to be used for generating the risk visualization image using a floor map, data relating to access are gathered for each floor.

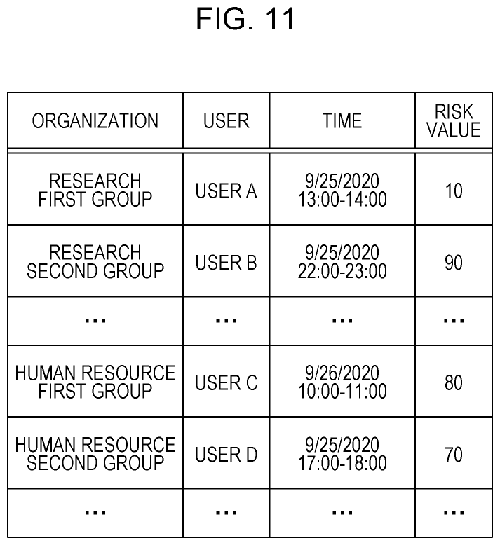

FIG. 11 is a diagram illustrating an exemplary configuration of aggregated data when the risk visualization image using an organization chart is selected. In the example illustrated in FIG. 11, as the aggregated data, information about respective items of “ORGANIZATION”, “USER”, “TIME”, and “RISK VALUE” are aggregated. These information items are aggregated every time access to an information file is made. The “ORGANIZATION” indicates an organization to which a user who accessed an information file belongs. The “USER”, the “TIME”, and the “RISK VALUE” are substantially the same items as in the exemplary data configuration illustrated in FIG. 10.

Next, the management server 10 generates a risk visualization image using the aggregated data described above. The risk visualization image is an image formed by drawing, based on the aggregated data, graphics visually representing the comprehensive risk values of the respective users on a base image such as a floor map, an organization chart, or the like. Here, the base image is a diagram representing the attribution of a user. For example, a floor map serving as the base image may be considered as a diagram indicating the attribution of a user, which is the place where the user accessed an information file. An organization chart serving as the base image may be considered as a diagram indicating the attribution of a user, which is the position of the user in the organization. Hereinafter, a graphic representing the comprehensive risk value of a user is referred to as a “risk graphic”. As the risk graphic, what type of graphic is to be used and how the magnitude of the risk value is to be expressed using the risk graphic are not specifically limited to any particular example. For example, the risk graphic may be a circle, the number of information files accessed may be indicated by the size of the circle, and the magnitude of the risk value may be indicated by the color of the circle. The risk graphic is also a graphic indicating an operator who performed an operation of making access to an information file. Alternatively, the identification information of a user may be displayed in the vicinity of each risk graphic or in such a manner as to overlap the risk graphic. As the identification information of a user, the name of the user, an ID, or the like may be displayed, or an image representing the user may be displayed. By displaying the identification of a user in connection with a risk graphic, the user associated with the risk graphic may be recognized even in the case where the user accesses an information file from a place different from the user□s desk or in the case where the user moves while keeping access to an information file.

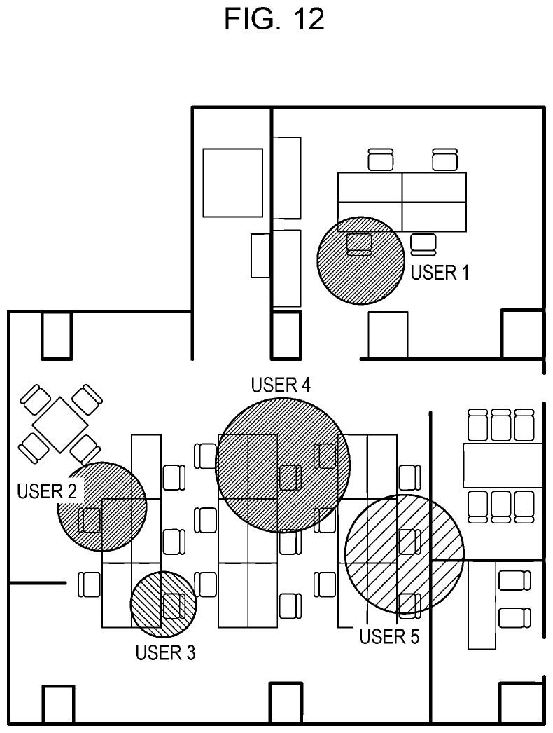

FIG. 12 is a diagram illustrating an example of the risk visualization image using a floor map. In the example illustrated in FIG. 12, risk graphics relating to five users, a user 1 to a user 5, are displayed on the floor map. The risk graphic is displayed as a circle for each user. As described above, the number of information files accessed is indicated by the size of the circle of the risk graphic, and the magnitude of the risk value is indicated by the color of the circle of the risk graphic. In the example illustrated in FIG. 12, the difference in the color of the risk graphic is expressed by adding a different hatching pattern to a different risk graphic. For example, access to information files made by the users 1, 2, and 4 have the same risk value, and the risk values of access to information files made by the users 3 and 5 are different from the risk value of the access made by the users 1, 2, and 4. The number of information files accessed by the user 4 is greater than the number of information files accessed by the user 1 or the user 3. The location where the risk graphic of each user is displayed on the floor map of FIG. 12 corresponds to the place on the floor where each user accessed an information file using the terminal apparatus 50.

Upon receiving a designation of the time, the risk visualization image illustrated in FIG. 12 illustrates the access status of the respective users at the designated time. Accordingly, when a different time is designated, the access status of the respective users at a different designated time is illustrated, and thus the content of the display may change in some cases. For example, in the case where a certain user ends his/her access to an information file, the risk graphic relating to this user is displayed in such a manner as to correspond to a smaller comprehensive risk value. Specifically, for example, a circle that serves as the risk graphic becomes smaller in size, and the color of the circle changes. When the place of user□s access changes between two different times, such as in the case where a user who was at his/her desk moves to a meeting room or in any other similar cases, the arrangement of the risk graphics changes between two risk visualization images corresponding to the respective times. Furthermore, in the case where the risk value based on the place of the access is set to different values depending on the time period of the day, even when the same user is accessing the same information file, depending on the designated time, the comprehensive risk value may change, and thus the risk graphics may change.

As illustrated in the flowchart of FIG. 7, the access history is periodically generated and stored in the access log DB 20 until the terminal apparatus 50 ends access to the information file. Accordingly, the risk visualization image may be updated according to this time interval at which the access history is generated. Because of this, by updating the risk visualization image every time a new access history is generated, for a user who moves while keeping access to a document file, the movement of the risk graphic is shown like a frame-by-frame advancing moving image.

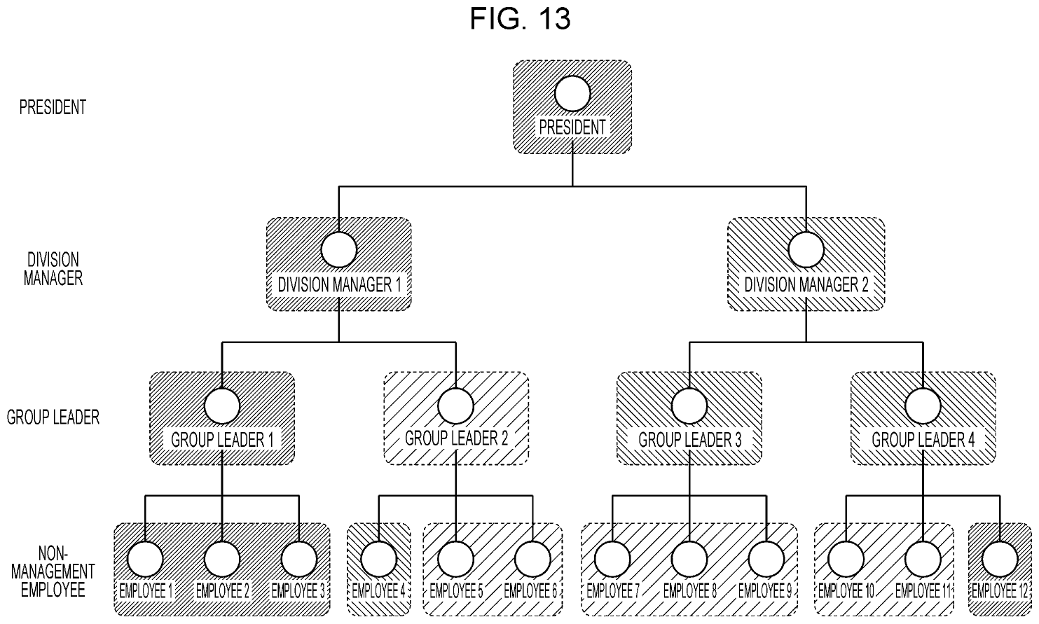

FIG. 13 is a diagram illustrating an example of the risk visualization image using an organization chart. In the example illustrated in FIG. 13, on an organization chart with a hierarchy including a president, division managers, group leaders, and non-management employees, risk graphics are displayed for the respective users who are members of this organization. In the example illustrated in FIG. 13, a rectangle with rounded corners (rounded rectangle) is used as the risk graphic. In the risk graphic illustrated in FIG. 13, the number of accessed information files is not indicated, and the magnitude of the risk value is indicated by the color of the graphic. As is the case with the example illustrated in FIG. 12, the difference in the color of the risk graphic is expressed by adding a different hatching pattern to each risk graphic. Here, in the risk visualization image using an organization chart, in addition to the display of the risk graphics for individual users, a risk graphic for assembled plural users such as a group, a division, or the like may be displayed. For example, comprehensive risk values of a plurality of users who are conducting a single project may be aggregated and displayed as a comprehensive risk value of the project group. In this case, as the comprehensive risk value of the project group, the maximum value of the comprehensive risk values of the respective users who are member of this project group may also be used.

In the example illustrated in FIG. 13, some risk graphics, in each of which a plurality of users are gathered, are displayed in part of the display indicating the non-management employees. For example, with regard to employees 1, 2, and 3 who are subordinate to a group leader 1, a risk graphic is displayed for access to one or more information files made in a group consisting of these employees 1, 2, and 3. Of employees 4, 5, and 6 who are subordinate to a group leader 2, with regard to the employee 4, a risk graphic is displayed for access to one or more information files made individually, and with regard to the employees 5 and 6, a risk graphic is displayed for access to one or more information files made in a group consisting of these two employees. Alternatively, in the case where an administrator performs an operation of selecting a plurality of users from the organization chart on the risk visualization image of FIG. 13, the management server 10 may be configured to display a risk graphic indicating aggregated comprehensive risk values of the selected users.

The risk visualization image illustrated in FIG. 13 may be generated based on the access history at a designated time as is the case with the risk visualization image illustrated in FIG. 12 or may be generated based on past records of access to one or more information files during a certain time period. For example, in the case where a risk visualization image based on past records of a one month period is generated, the comprehensive risk values for this one month period are calculated for each user based on the access history of each user in this one month period. Subsequently, for each user, the maximum value of the comprehensive risk values obtained for the one month period is identified, and this maximum value may be used as the comprehensive risk value of each user in this one month period. In this case, a risk graphic for assembled plural users may also be displayed in addition to the display of the risk graphics based on the comprehensive risk values of the respective users.

As described with reference to the flowchart of FIG. 8, the risk visualization image described above is generated according to the type of the risk visualization image selected upon receiving a designation in S202. Here, the management server 10 may be configured in such a manner as to be able to receive a switching operation in the state where a risk visualization image of one type is being displayed and switch the display to a risk visualization image of another type. For example, the management server 10 may receive a switching operation in the state where one of the risk visualization images illustrated in FIG. 12 and FIG. 13 is being displayed and switch the display to the other risk visualization image.

In this case, the management server 10 may receive the designation of a particular risk graphic in one of the risk visualization images and switch the display to an image that is the other risk visualization image and includes a user corresponding to the designated risk graphic. Specifically, when the designation of a particular risk graphic is received in the risk visualization image of a floor map, the management server 10 switches the display to the risk visualization image of an organization chart that includes a user corresponding to the designated risk graphic. On the other hand, when designations of a risk graphic for a particular member and the date and time are received in the risk visualization image of an organization chart, the management server 10 switches the display to the risk visualization image of a floor map that includes a user corresponding to the designated risk graphic and is based on the access history of the designated date and time.

Furthermore, the management server 10 may alternatively display, on a single screen of the display apparatus, both a risk visualization image of an organization chart including a particular user and a risk visualization image of a floor map that includes that user and is based on the access history of a particular date and time.

When the designation of a particular risk graphic is received in the risk visualization image, the management server 10 may display detailed information about the status of access to an information file made by a user who corresponds to the designated risk graphic. As the detailed information, for example, the degree of secrecy of the accessed information file and the set risk value corresponding to that degree of secrecy, the time of access and the set risk value corresponding to that time of access, the place of access and the set risk value corresponding to that place of access, and the like may be displayed.

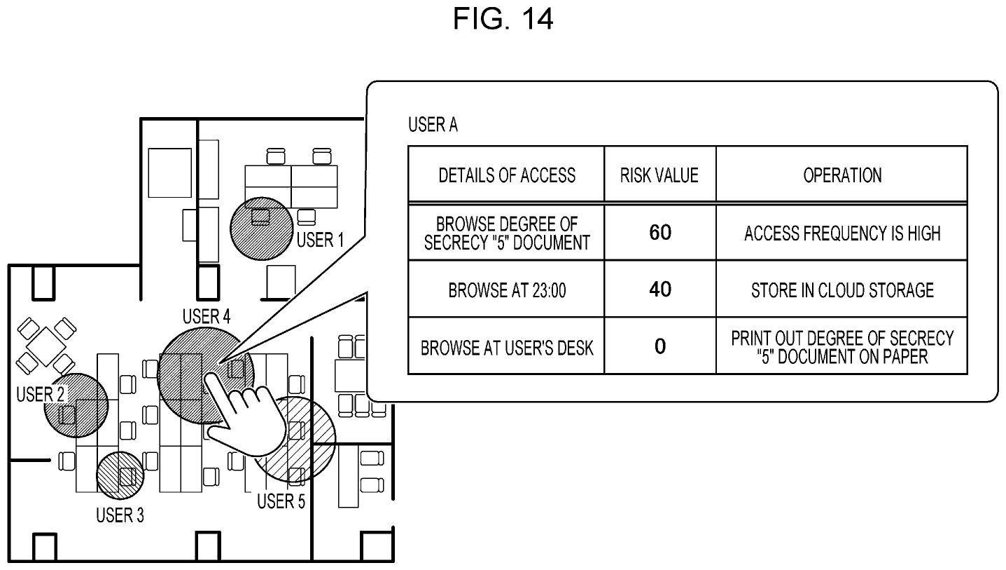

FIG. 14 is a diagram illustrating an example of a display of detailed information. In the example illustrated in FIG. 14, a pop-up window showing details of the access, the risk value based on the details of the access, and information about an operation performed on an information file, which is an access target, is displayed on the top of the risk visualization image of a floor map. Specifically, with regard to the access target, that a document (document file) of the degree of secrecy “5” is browsed as the details of the access, the risk value “60” thereof, and a message stating that the frequency of access to this document is high as the content of the operation are displayed. With regard to the time of access, that the browsing is performed at the time 23:00 as the details of the access, the risk value “40” thereof, and a message stating that this document is stored in a cloud storage as the content of the operation are displayed. With regard to the place of access, that the browsing is performed at the user□s desk as the details of the access, the risk value “0” thereof, and a message stating that this document is printed on paper as the content of the operation are displayed.

Thus far, the exemplary embodiment of the present disclosure is described. However, the technical scope of the present disclosure is not limited to the exemplary embodiment described above. For example, in the exemplary embodiment described above, it the management server 10 is configured to include the access log DB 20, the degree of secrecy DB 30, and the user attribution DB 40. Alternatively, each database may be configured as a separate database server, and the management server 10 may be configured to obtain required information from each database server to calculate the risk value. In the case with such configuration, part of functionality of the management server 10 may be realized in a terminal apparatus used by an administrator of the risk management system 100. For example, the risk calculation, the image generation, and the display may be performed by the terminal apparatus of the administrator. Other various modifications or substitutions of constituent elements are included in the present disclosure as long as they do not depart from the scope of technical principle of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
obtain operation information relating to an operation performed on an information asset, the operation information including degree of secrecy of the information asset operated, a time period of the operation, and a place of the operation;
determine a security risk of the operation performed on the information asset based on the operation information; and
display a determined security risk of the operation on a display apparatus using a graphic, the graphic indicating an operator of the operation performed on the information asset and representing a level of risk using a predetermined display mode.

2. The information processing apparatus according to claim 1, wherein the processor is configured to:
calculate, in determining the security risk, a value of the security risk of the operation performed on the information asset based on a risk value set according to the degree of secrecy of the information asset and a risk value set according to the time period and the place; and
display, in displaying the security risk, the graphic using a display mode determined based on the value of the security risk.

3. The information processing apparatus according to claim 2, wherein the processor is configured to:
obtain the value of the security risk of the operation performed on the information asset is obtained by adding the risk value set according to the degree of secrecy of the information asset to a value of a larger one of a risk value set according to the time period and a risk value set according to the place.

4. The information processing apparatus according to claim 1, wherein the processor is configured to:
display, on the display apparatus, a diagram representing an attribution of the operator of the information asset in such a way that the graphic is arranged on the diagram.

5. The information processing apparatus according to claim 4, wherein
the diagram representing the attribution of the operator of the information asset is a map indicating a place where the operator performed the operation.

6. The information processing apparatus according to claim 5, wherein the processor is configured to:
receive a designation of date and time; and
display, on the display apparatus, the map on which the graphic at a designated date and time is arranged.

7. The information processing apparatus according to claim 4, wherein
the diagram representing the attribution of the operator of the information asset is an organization chart of an organization to which the operator belongs.

8. The information processing apparatus according to claim 7, wherein the processor is configured to:
display, for each operator illustrated in the organization chart, the graphic reflecting a security risk determined for an operation performed on the information asset by each operator during a predetermined time period.

9. The information processing apparatus according to claim 8, wherein the processor is configured to:
use, as the security risk during a predetermined time period, a maximum value of security risks determined during the predetermined time period.

10. The information processing apparatus according to claim 4, wherein the processor is configured to:
be able to display, as the diagram representing the attribution of the operator of the information asset, diagrams of a plurality of types at a same time or by switching therebetween, the diagrams of the plurality of types including a map indicating a place where the operator performed an operation and an organization chart of an organization to which the operator belongs; and
display, upon receiving a designation of an operator in one of the diagrams, another of the diagrams that includes a graphic of a designated operator.

11. A non-transitory computer readable medium storing a program causing a computer to execute a process, the process comprising:
obtaining operation information relating to an operation performed on an information asset, the operation information including degree of secrecy of the information asset operated, a time period of the operation, and a place of the operation;
determining a security risk of the operation performed on the information asset based on the operation information; and
displaying a determined security risk of the operation on a display apparatus using a graphic, the graphic indicating an operator of the operation performed on the information asset and representing a level of risk using a predetermined display mode.

12. An information processing method comprising:
obtaining operation information relating to an operation performed on an information asset, the operation information including degree of secrecy of the information asset operated, a time period of the operation, and a place of the operation;
determining a security risk of the operation performed on the information asset based on the operation information; and
displaying a determined security risk of the operation on a display apparatus using a graphic, the graphic indicating an operator of the operation performed on the information asset and representing a level of risk using a predetermined display mode.
